(19) United States
(12) Patent Application Publication
(10) Pub. No.: US 2011/0082867 A1
(43) Pub. Date: Apr. 7, 2011

(54) SYSTEM, METHOD, AND COMPUTER PROGRAM PRODUCT FOR ANALYZING DRUG INTERACTIONS

(75) Inventors: William A. Bruns, Sante Fe, NM (US); Daniel A. Cooper, Chino Hills, CA (US); Robert V. Montz, La Verne, CA (US); Kristen L. Hostetter, Huntington Beach, CA (US); Michael A. Homewood, Castle Rock, CO (US); Sam M. Schulte, Corona, CA (US)

(73) Assignee: NeX Step, Inc., Lakewood, CO (US)

(21) Appl. No.: 12/643,806

(22) Filed: Dec. 21, 2009

Related U.S. Application Data
(60) Provisional application No. 61/249,080, filed on Oct. 6, 2009.
(60) Provisional application No. 61/278,366, filed on Oct. 6, 2009.

(51) Int. Cl. G06F 17/30

(52) U.S. Cl. 707/748; 707/736; 707/E17.044

(57) ABSTRACT

A method, system, and computer program product. A method includes receiving a patient profile, the patient profile including a patient substance profile identifying a plurality of substances consumed by a patient and at least one patient-specific gene variant. The method includes identifying a gene associated with a first one of the plurality of substances, and performing a weighing process to determine an interaction between the first substance and the gene. The method includes producing a summary by the data processing system according to the determined interaction. Another method includes identifying at least one additional substance that has a potential effect on the patient, presenting the at least one additional substance to a user, receiving and storing a change to the patient profile based on the at least one additional substance.

### CROSS REFERENCE TO RELATED APPLICATION

This application claims priority to U.S. Provisional Application 61/249,080, filed Oct. 6, 2009, and U.S. Provisional Application 61/278,366, filed Oct. 6, 2009, both of which are hereby incorporated by reference.

### TECHNICAL FIELD

The present disclosure is directed, in general, to software, systems, and methods for analyzing drug interactions.

### SUMMARY OF THE DISCLOSURE

Various embodiments include methods, systems, and computer program products.

One method includes receiving a patient profile, the patient profile including a patient substance profile identifying a plurality of substances consumed by a patient and at least one patient-specific gene variant. The method includes identifying a gene associated with a first one of the plurality of substances, and performing a weighing process to determine an interaction between the first substance and the gene. The method includes producing a summary by the data processing system according to the determined interaction. A system configured to perform a similar method is also disclosed, as is a computer-readable medium encoded with instructions for performing a similar method.

Another method includes receiving a patient profile in a data processing system, the patient profile including a patient substance profile identifying at least one initial substance consumed by a patient. The method includes identifying at least one additional substance that has a potential effect on the patient, presenting the at least one additional substance to a user, receiving and storing a change to the patient profile based on the at least one additional substance. A system configured to perform a similar method is also disclosed, as is a computer-readable medium encoded with instructions for performing a similar method.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 depicts a block diagram of a data processing system in which an embodiment can be implemented;

FIG. 2 depicts a process in accordance with disclosed embodiments;

FIG. 3 depicts an example of an Interactive Display and summary in accordance with various embodiments;

FIG. 4 depicts a flowchart of a weighing process as used by various embodiments; and

FIGS. 5-8 depict example summary tables in accordance with disclosed embodiments.

### DETAILED DESCRIPTION

The figures discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

Disclosed embodiments include a system, method, and computer program product that improves drug therapy and decrease the probability of adverse drug reactions through the use of genetic information and interaction research.

The disclosed embodiments evaluate the complex relationships of pharmacogenomic substances, including both prescription and over-the-counter (OTC) drugs, and nutrigenomic substances, including foods and nutrients. These interactions a can be displayed in a simple, intuitive, and dynamic graphic presentation. The analysis provides personalized, patient-specific information for healthcare practitioners to consider when determining the correct combination and dosage of drugs, supplements, and nutrients.

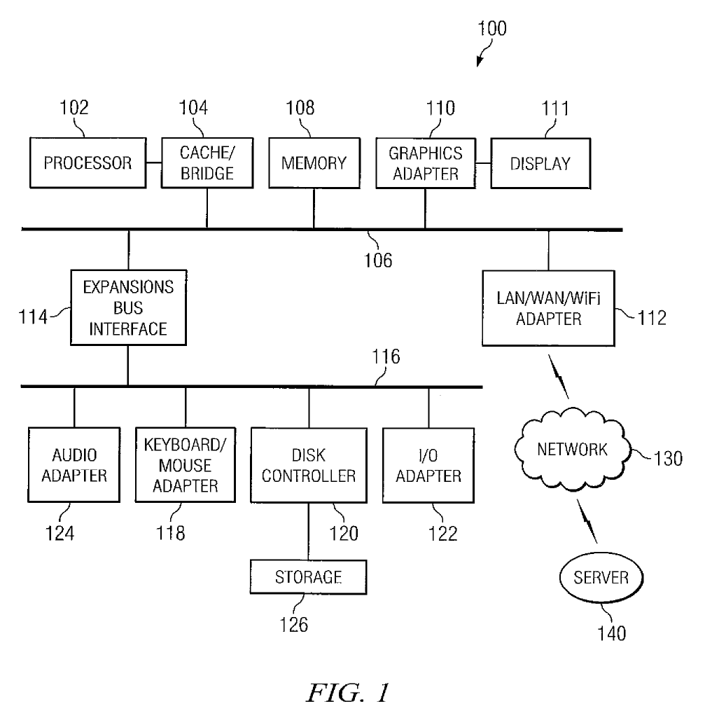

FIG. 1 depicts a block diagram of a data processing system in which an embodiment can be implemented for performing processes as described herein. The data processing system depicted includes a processor 102 connected to a level two cache/bridge 104, which is connected in turn to a local system bus 106. Local system bus 106 may be, for example, a peripheral component interconnect (PCI) architecture bus. Also connected to local system bus in the depicted example are a main memory 108 and a graphics adapter 110. The graphics adapter 110 may be connected to display 111.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 can be connected to a storage 126, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, etc.

Those of ordinary skill in the art will appreciate that the hardware depicted in FIG. 1 may vary for particular implementations. For example, other peripheral devices, such as an optical disk drive and the like, also may be used in addition or in place of the hardware depicted. The depicted example is provided for the purpose of explanation only and is not meant to imply architectural limitations with respect to the present disclosure.

A data processing system in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 112 can be connected to a network 130 (not a part of data processing system 100), which can be any public or private data processing system network or combination of networks, as known to those of skill in the art, including the Internet. Data processing system 100 can communicate over network 130 with server system 140, which is also not part of data processing system 100, but can be implemented, for example, as a separate data processing system 100.

The disclosed systems and methods can optimize drug therapy and decrease the probability of adverse drug reactions and adverse drug events through the use of genetic information and interaction research.

Systems and methods according to disclosed embodiments take the complex relationships of pharmacogenomic substances (Drug, Over the Counter) and nutrigenomic (Foods and Nutrients including, but not limited to, herbs, vitamins, minerals, homeopathic substances, exotoxins and endotoxins) and simplifies their interactions in a dynamic graphic presentation. The analysis provides personalized, patient-specific information for healthcare practitioners to consider when determining if the addition of a new drug, OTC, nutrient and/or food into an existing protocol of drugs, OTCs, nutrients and/or foods has a probability of increasing the potential of an ADR/ADE. Dosage modifications of a drug, OTC, nutrient and/or food may be indicated as a result of the analysis.

In some embodiments, disclosed systems do not make any decisions or draw any conclusions regarding clinical or medicinal care for the user. Rather, the system provides data and information that the user or other professional may consider when reviewing the patient's medication profile.

The disclosed embodiments store substance interaction information. These interactions between the genes and the substances are stored in a database in a computer-readable storage medium, and can be defined by a user. This is completed through the Data Entry Drug Interface tool (DEDI) which facilitates the assignment of research work and the completion of the substance detailed information.

In each of the user interfaces or “screens” described herein, those of skill in the art will recognize that various embodiments include interacting with a user on a stand-alone data processing system for direct entry, interacting with a user with a specialized application interface executing on a client data processing system in communication with a server data processing system that is performing some or all of the other described processes, or interacting with a user via a web browser or similar interface executing a client data processing system in communication with such a server system. Similarly, various data or results displayed to a user can be done in any of these and other ways.

Interaction information required by various embodiments is typically completed by research scientists who research available genetic and substance information, interpret it, and implement their findings. This information can then be added to the system as substance interaction information.

DEDI facilitates the entry of the interaction information into the database. The process of defining an interaction consists of several elements, including adding a new or editing an existing interaction definition; adding/editing a substance warning; adding/editing a substance side effect; adding/editing a substance citation, and adding notes to Approver. While various embodiments include receiving any of this information from a user, other embodiments include loading this information from a database or external source, such as over a computer network.

Adding a new or editing an existing interaction definition allows the research scientist or other user to add or edit drug interactions for use by system. This section can be repeated as often as necessary to ensure all substance interaction data is captured. Each interaction consists of entering at least one of the following attributes:

Gene Definition: For a given substance, identifies the gene, involvement strength (Major, Moderate, or Minor), and involvement type (Substrate, Inhibitor, or Inducer).

Phenotype Dose Guidelines: For a given substance, identifies the single dose and maintenance dose characteristics for the following gene variants: Poor Metabolizer, Intermediate Metabolizer, Extensive Metabolizer, Hyper Inducer, and Ultra Rapid Metabolizer. Of course, other terms can be used to describe these characteristics.

Interaction Citation: For a given substance, identifies specific citations related to the gene interaction information as determined by the Research Scientist including the source reference for the citation.

Adding/editing a substance warning provides for entry or review of a substance's specific warning by the Research Scientist or other user. Warning information for the selected substance can pulled from a source data such as that provided by First DataBank and made available for review. If there is no Warning source data available, the Research Scientist or other user can enter this information. This section can be repeated as often as necessary to ensure all substance specific warnings are captured. The substance warning section can include one or more of the following attributes:

Warning Title Short title for the warning entry

Warning Description Short description for the warning entry

Warning Detail Detailed narrative for the full warning information detail

Warning Source A menu listing approved source entities

Warning URL The internet URL (address) if available or necessary

Warning Date The date of the publishing or entering of the warning

Adding/entering a substance side effect provides for entry or review of a substance specific side effect by the Research Scientist or other user. Side Effect information for the selected substance is pulled from source data such as that provided by First DataBank and made available for review. If there is no Side Effect source data available, the Research Scientist or other user can enter this information. This section can be repeated as often as necessary to ensure all substance specific side effects are captured. The substance side effect section includes one or more of the following attributes:

Substance Side Effect Detail Detailed narrative for the full side effect information detail
Substance Side Effect Source A menu listing approved source entities
Substance Side Effect URL The internet URL (address) if available or necessary
Substance Side Effect Date The date of the publishing or entering of the side effect

Adding/editing substance citation provides for entry or review of substance specific citations by the Research Scientist or other user. Citation information for the selected substance is pulled from source data such as that provided by First DataBank and made available for review. If there is no Citation source data available, the Research Scientist can enter this information. This section can be repeated as often as necessary to ensure all substance specific citations are captured. The substance citation section includes one or more of the following attributes:

Citation Title Short title for the citation entry

Citation Reference Detailed narrative for the full citation information detail

Citation Source A menu listing approved source entities

Citation URL The internet URL (address) if available or necessary

Citation Date The date of the publishing or entering of the citation

Adding notes to approver gives the Research Scientist or other user a place to enter notes to the “approver” or other person that would be reviewing the data provided to the system for completeness and accuracy. The notes to approver section can behave very similarly to online chat in that comments entered in this section can be tagged with the individuals name and date/time stamped. Subsequent comments added by the Approver, the Research Scientist, or another user will be appended to this list and the complete message dialog will be preserved. Thus, this section will maintain an audit trail of the review and entry comments for each substance.

Approve Substance Interaction Data: Once the substance interaction data is defined by the Research Scientist or other user, it is submitted for approval by a person referred to herein as the “Approver”. The Approver must review and approve the entire content of the substance interaction data before the data can be moved into production and made available to The Rₓ Factor application. If upon review corrections to the data are needed, the Approver can return the substance interaction data to the originating Research Scientist or any other Research Scientist for corrections.

Once approved, the data is transmitted to the production system or otherwise stored and made available for use in embodiments disclosed herein.

If the data in the production system needs to be edited, the Approver can identify any section of data for edit and that section will be immediately assigned to a Research Scientist for editing. Once the edits are complete and approved by the Approver, the edited data will be made available to the system.

Finally, all substance data elements can be monitored by the system and automatically flagged for review every twelve months or other selected period. This automatic review process ensures that all interaction data, warnings, citations, and side effects are reviewed and updated annually; thus, providing the most up-to-date information for use by the system.

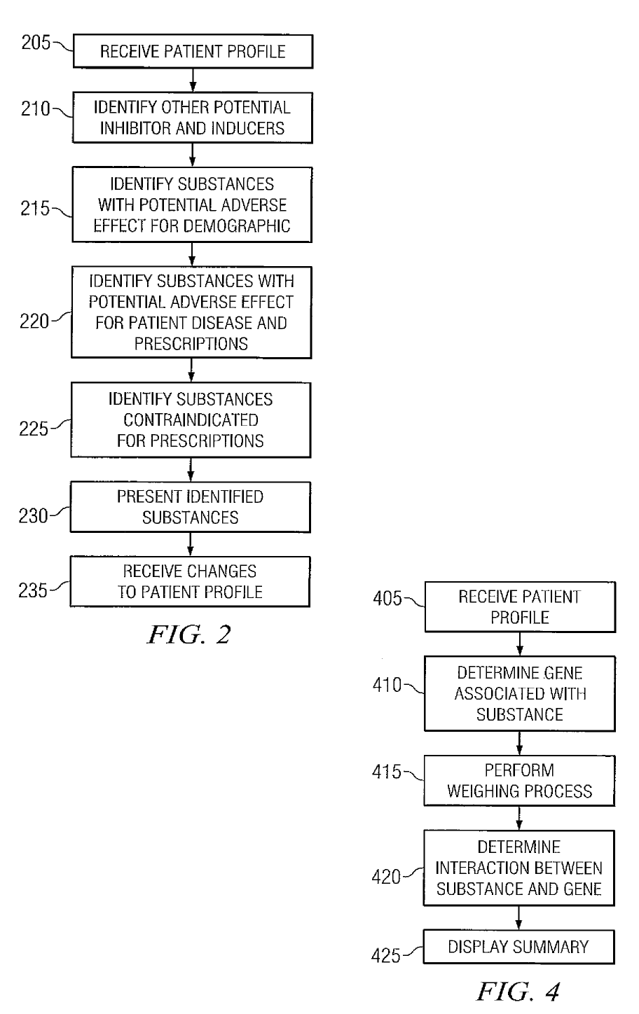

FIG. 2 depicts a process in accordance with disclosed embodiments. Various steps in the process are described in detail below. The process can be performed in a data processing system such as that depicted in FIG. 1, and can be performed by a server data processing system in communication with a client data processing system.

The system receives a patient profile (step 205), which can include loading it from storage, receiving it from another system or receiving it via a user interaction. One user interface for some embodiments enables the system to receive a patient's profile for consideration. The data entered during this stage and received by the system will be used to generate the Interaction Diagram and display all interaction information. Much of this data is optional. However, the more detail provided, the more accurate the interaction data and profile analysis. The patient profile, in some embodiments, consists of the following sections, though of course electronic or other forms of the profile may not specifically separate the data in this specific way:
Patient Information
Patient Disease/Diagnosis Profile
Patient Optional Phenotypic Profile
Patient Substance Profile

There are ways in which the Patient Profile data can be entered into the system. The most common is via an electronic interface with the client location where the patient profile data is received from a client location in electronic form. A second method of data entry includes manual entry on-line via user-interface forms, such as those that can be displayed in a dedicated application or web browser executing on a client system. This method can also be used to edit Patient Profiles that are saved within the application.

All Patient Profiles are given a unique name, determined by the user or the system, and are stored for future use. They can also be modified and manipulated by the user to facilitate hypothetical analysis.

A Patient Information form captures general personal and demographic data about the patient. This data is used primarily to distinguish between patients. However, several fields are also used in the analysis of the interaction data. These fields can include Gender, Date of Birth, and Ethnicity.

A Patient Disease/Diagnosis Profile form allows the user to enter the patient's disease/diagnosis, such as by selecting from a list of International Statistical Classification of Diseases and Related Health Problems (“ICD 9”) codes. All data on this screen can be optional. However, by filling out the disease/diagnosis profile, the interaction analysis will be able to provide information that is more comprehensive including more accurate alternative medication data.

A Patient Optional Phenotypic Profile form allows the user to enter the patient's individual gene variants. These gene variants can be used to provide patient-specific drug interaction reports, and described in more detail below. Gene variants are defined in some embodiments, for each subject gene, as:
EM: Extensive Metabolizer
IM: Intermediate Metabolizer
PM: Poor Metabolizer
URM: Ultra Rapid Metabolizer
HI: Hyper Inducer
   Of course, other labels can be used without departing from the scope of the disclosure.

Ideally, the phenotypic profile for the patient will be derived from the results of a specific lab test. However, this form does allow for hypothetical analysis. To differentiate between the two, the user is asked to identify if the results entered are from a certified lab test. If they are, then the data entered can be locked so that it cannot be modified for this profile. This is done to protect the integrity of the lab results. If the user answers “No” to this question, then it is assumed that the phenotypic profile is for hypothetical analysis and the data can be modified as needed.

All data on this form can be optional. However, the interaction analysis is significantly more complete if this data is present.

A Patient Substance Profile form allows the user to enter the patient's prescription Drugs, Over the Counter medications, Foods, Nutrients and other substances that they are consuming; consuming is understood in this context to include receiving the substance by any means, including orally, by injection, by inhalation, or otherwise. The form also allows for hypothetical analysis by adding alternative medication or flagging current medication as Inactive.

If the user chooses to delete a substance, the substance will be removed.

Substances can be identified as “active” or “inactive”. Substances that are identified as Active will be included in the interaction analysis. Substances identified as Inactive will be not be displayed in the Interaction Diagram or included in the interaction analysis, but they will be displayed in the Patient Profile View as an unchecked substance making them accessible for further hypothetical analysis.

A Patient Profile Analysis engine, in various embodiments, is a system and method designed to prompt the user to consider expanding the Patient Profile by providing a list of substances that, if being consumed, might interact with other substances in the profile, produce contraindications, or be impacted by the patient's phenotypic information. This is done to prompt the physician to delve deeper into the patient's medication profile since physicians may not be accustomed to asking for Over the Counter (OTC), Food, and Nutrient Supplements that the patient may be taking. The substance list presented on this form is derived by analyzing the substances, diseases/diagnosis, phenotypic information, and patient demographic information entered previously. The system performs the following steps, using rules as described herein.

The system reviews every prescription medication in the Patient Profile that is a Major Substrate with regard to a specific gene and identifies or lists any Over the Counter, Foods or Nutrients that are Inhibitors or Inducers to the same gene that are not already in the Patient Profile (step 210). Identifying the other potential inhibitors and inducers can enable a user to revise the patient profile to include other substances that may not have been originally considered but that have a specific effect with regard to the specific medications that are included in the patent profile.

The system reviews the patient demographic information (for example, gender, ethnicity, date of birth) in the Patient Profile and identifies or lists any substance that if taken in combination with this information and the prescription drugs listed in the Patient Profile will or could result in an adverse effect (215). Identifying substances with potential adverse effects enable a user to consider possible problems that are specific to the patient's demographics.

The system reviews the disease/diagnosis information in the Patient Profile and list any substance that if taken in combination with the disease/diagnosis or the prescription drugs (collectively, the patient's “medical condition”) listed in the Patient Profile will result in an adverse effect (220). Identifying substances with potential adverse effects can enable a user to consider possible problems that are specific to the patient's condition.

The system reviews every prescription medication in the Patient Profile and identifies or lists any Over the Counter medications, Foods, or Nutrients or other substances that have a contraindication or other interaction with the prescription medications (step 225).

Together, steps 210-225 are used to identify other substances (not already in the patient profile) that may effect the patient's pharmaceutical regimen, based on the information in the patient profile, so that the user or patient can determine if the patient is also taking or consuming any of these other substances. For example, it may be that a common vegetable has a known interaction with one or more of the patient's medications, but would not normally be included in the patient profile. By identifying this vegetable based on the interaction, the patient can be queries as to whether he or she consumes the vegetable, and if so, the patient profile can be updated to include this information.

When the analysis is complete, a list of all identified substances is presented to the user for inclusion consideration in the Patient Profile, which can include displaying this data, storing it, transmitting it, or otherwise (step 230). The user has the option of adding any substance from the list to the Patient Profile. The system receives and stores any changes to the patient profile (step 235).

A Patient Profile Review screen displays a summary of the Patient Profile for review; this can be part of displaying the identified substances above. This is particularly useful when the Patient Profile data is entered electronically, such as via a Health Level Seven (HL7) interface. HL7 is one of several American National Standards Institute (ANSI) -accredited Standards Developing Organizations (SDOs) operating in the healthcare arena. Most SDOs produce standards (sometimes called specifications or protocols) for a particular healthcare domain such as pharmacy, medical devices, imaging or insurance (claims processing) transactions. Health Level Seven's domain is clinical and administrative data, and the exchange of data via an HL7 interface is known to those of skill in the art.

The user has several possible actions, including:
Edit Profile Substances Returns to the Patient Substance Profile screen
Enter a New Profile Clears the Patient Profile data currently active and returns to the Patient Information screen
Review Analysis Returns to the Patient Profile Analysis screen and runs the analysis again for the Patient Profile.
View Interactive Display Displays the Interaction Diagram and all analytical information regarding the warnings, side effects, citations, drug interactions, dosing considerations, and alternative medications

If a user selects the View Interactive Display button from the Patient Profile Review screen, the information entered in the Patient Profile is examined by the system. The result is the creation of the Interaction Diagram and the display of the pertinent summary data, citations, warnings, side effects, drug interactions, dosing recommendations, and alternative drugs.

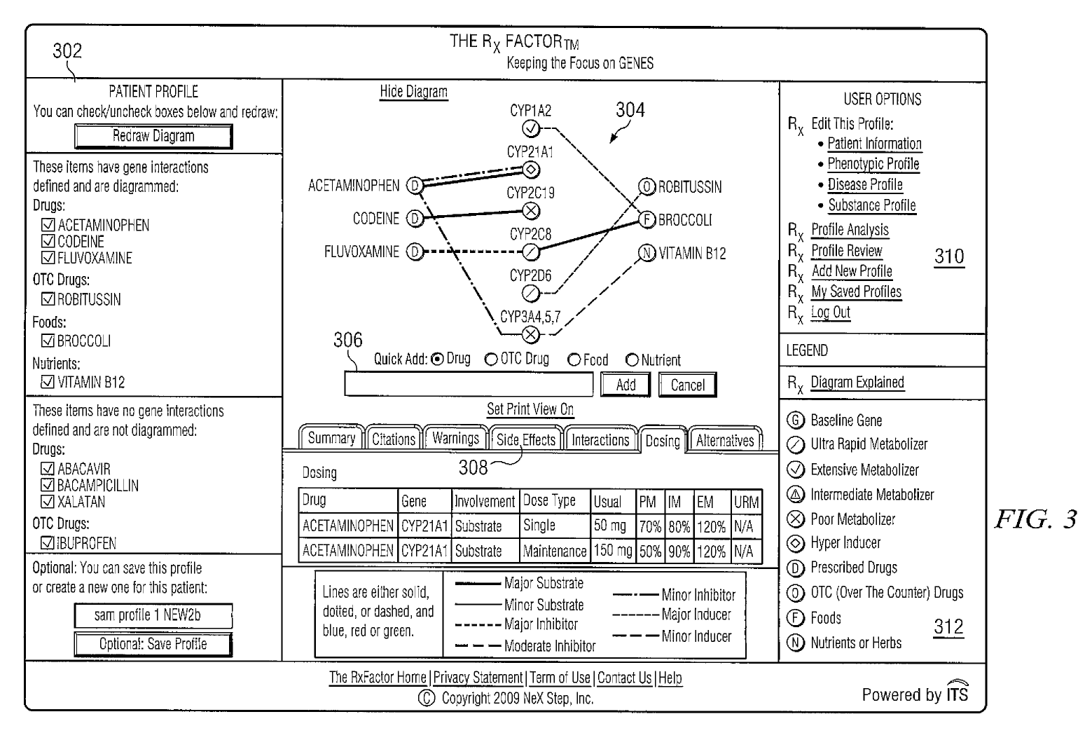

FIG. 3 depicts an example of an Interactive Display and summary in accordance with various embodiments. Note that while these drawings appear as grayscale or line drawings, various embodiments use color coding as described herein, though of course the actual colors used can change. The Interactive Display is broken up into six distinct sections:
Patient Profile Section 302 A view of all active and inactive substances entered during the Patient Profile load process that are used to derive content included in the Interaction Diagram and the Information Tabs.
Interaction Diagram 304 A graphical representation of the substances and phenotypic information entered in the Patient Profile and their interaction with the associated genes.
Quick Add 306 A means of quickly adding substances to the Patient Profile.
Information Tabs 308 A multi-tabular area detailing information pertaining to the content of the Patient Profile.
User Options 310 A navigational area within display.
Legend 312 A colorful and visual definition of the elements used to produce the Interaction Diagram

The Patient Profile Section 302 displays all substances (including Drugs, Over the Counter, Foods, Nutrients, and any others) that were entered as part of the Patient Profile. These substances are displayed with checkboxes which allow the user to remove a substance from the Interaction Diagram and Information Tabs by un-checking the associated box and redrawing the diagram. This feature helps the user with hypothetical analysis by visually representing the impact of adding or removing a substance from the profile.

The substances in this section can be presented alphabetically in order of Drugs, Over the Counter, Foods, and Nutrients and are divided into two groups. The first group includes all substances that contain gene-interaction data within the system database. The second group consists of those substances that do not have gene interaction data in the database. This division is useful as the research material for some drugs is incomplete or unavailable. Over time, the belief is that number of substances displayed in the second group will decrease.

Finally, the user is provided the option of saving any changes made to the Patient Profile during the use of the Interactive Display under the same name or as a new Patient Profile. This allows any hypothetical analysis to be saved for later access and review.

The Interaction Diagram 304 is a graphical representation of the prescription Drugs, OTCs, Foods, and Nutrients connected by a color-coded line to the genes they interact with. Note that the particular colors and symbols described below are arbitrary and could be changed. The genes are in the center of the diagram with the prescription drugs to the users left and the OTCs, Foods, and Nutrients to the user's right. The intent of the color-coding is to be able to see at a glance the critical interaction areas—which are displayed in red—and the genes that are not functioning at maximum potential.

The Interaction Diagram 304 is comprised of the following line segments:
Solid Colored Lines Used to identify Major pathways of metabolism for Substrates (blue), Inducers (green), and Inhibitors (red)
Dashed Colored Lines Used to identify Moderate pathways of metabolism for Substrates (blue), Inducers (green), and Inhibitors (red)
Dotted Colored Lines Used to identify Minor pathways of metabolism for Substrates (blue), Inducers (green), and Inhibitors (red)

In addition, colored symbols are used in some embodiments to represent the Gene Icons when the patient's genetic phenotype has been entered in the Patient Profile. These colored symbols are intended to identify the presence of the following metabolic factors and gene variants:
Light Blue with Letter “G” Identifies a Baseline Gene
Blue with Lighting Bolt Identifies a Ultra Rapid Metabolizing Gene
Green with Check Mark Identifies a Extensive Metabolizing Gene
Red with Letter “X” Identifies a Poor Metabolizing Gene
Purple with Diamond SymbolIdentifies a Hyper Inducing Gene

Other symbols that comprise the Interaction Diagram include, in some embodiments:
Gray with Blue Letter “D” Identifies a Prescription Drug
Gray with White Letter “O” Identifies a OTC (Over The Counter)
Gray with Black Letter “F” Identifies a Food
Gray with Green Letter “N” Identifies a Nutrient

Immediately above the Interaction Diagram is a link that allows the diagram to be hidden. This will allow the users the ability to remove the diagram and provide more space for the Information Tabs. Immediately below the Quick Add feature 306 is the ability to activate the Print View mode. This mode displays all content available on the Information Tabs on the screen making the information suitable for sending to a printer, if desired.

The Quick Add feature 306 provides the ability to quickly add substances to the Patient Profile without having to go back to the Patient Substance Profile screen. As a result, the user can add substances to assist with their hypothetical analysis and quickly redraw the Interaction Diagram and repopulate the Information Tabs without leaving this screen.

Substance research and narratives are displayed within the seven Information Tabs 308 located in the middle of the screen. The tabs consist of Summary, Citations, Warnings, Side Effects, Drug Interactions, Dosing Recommendations, and Drug Alternative considerations.

The Summary Tab is a simple and color-coded interpretation of the Interaction Diagram created using the processes described herein. All Major Substrate drugs that fall outside the range of a normal dose based on this analysis are listed along with a dosing consideration and a link to alternative medications.

The summary information listed is for consideration only and is not intended as a recommendation. Further, the summary information listed is not intended to replace the expertise provided by the physician or pharmacist.

Biological considerations that may affect the substances entered in the Patient Profile (such as Age, Ethnicity, and Gender) will be listed on this tab as well. The contents of this tab are sorted by significance of the interaction affect with the most significant affects listed first.

One example of a process for weighing interactions, as used with this tab, is disclosed in more detail below.

The Citations tab lists all substance citations provided by First DataBank or by other sources for the substances displayed. A brief description of the citation is listed in the tab with a link that will allow the user to read the full citation, if desired. In addition, each citation includes a link to the source of the citation that will take the user directly to the source publication on the internet.

Citations can be presented alphabetically in order of Drugs, Over the Counter, Foods, and Nutrients.

The Warnings tab lists all substance warnings provided by First DataBank or by other sources for the substances displayed. The warning statements may advise against unsafe practices or describe a potentially hazardous situation that, if not avoided, could result in death or injury. A brief description of the warning is listed in the tab with a link that will allow the user to read the full warning, if desired. In addition, each warning includes a link to the source of the warning that will take the user directly to the source publication on the Internet. Warnings can be presented alphabetically in order of Drugs, Over the Counter, Foods, and Nutrients.

The Side Effects tab lists all substance side effects provided by First DataBank or other sources. Side effects are an unintended or undesirable consequence of medical treatment judged secondary to a main or therapeutic. A brief description of the side effect is listed in the tab with a link that will allow the user to read the full side effect, if desired. In addition, each side effect includes a link to the source of the side effect that will take the user directly to the source publication on the internet. Side effects can be presented alphabetically in order of Drugs, Over the Counter, Foods, and Nutrients.

The Interactions tab lists all substance interactions including Drug-Drug, Drug-OTC, Drug-Foods/Nutrients, and OTC-OTC interactions. All interaction data is stored within the system database and is typically provided by First DataBank or other sources. A brief description of the interaction and the substances involved is listed in the tab with a link that will allow the user to view the substance-class relationship listing.

Each interaction is displayed as a link that, when clicked on, takes the user to an interaction report containing details about the interactions such as:
Medical warnings
How the interaction occurs
What might happen if the interaction continues
What should be done to mitigate this interaction
Various source and citation references

Interactions can be presented alphabetically by substance and then in order of severity: contraindicated, severe, and moderate.

The Dosing tab lists all substance dosing recommendations as determined by the system and can be based on the processes discussed herein. These recommendations can be displayed in table format identifying the drug, gene, metabolic interaction, dosing type (single or maintenance), and appropriate dosing suggestion for each gene variant type: Poor Metabolizer, Intermediate Metabolizer, Extensive Metabolizer, Ultra Rapid Metabolizer, and Hyper Inducer.

Dosing recommendations are typically presented for drugs only and are sorted alphabetically.

The Alternatives tab lists all substance alternatives as determined by the system and can be based on the processes discussed herein. Each alternative substance displayed alongside the substance it can replace. In addition, each alternative substance is provided as a link that will provide the user with detailed information regarding that substance.

The alternative substances listed are for consideration only and are not intended as recommendations. Further, the alternative substances listed are not intended to replace the expertise provided by the physician or pharmacist. Alternative substance considerations can be presented alphabetically in order of Drugs, Over the Counter, Foods, and Nutrients.

The User Options section 310 of the Interactive display allows the user to manage the Patient Profiles or log out of the system. Specifically, within this section, the user can perform functions including:
Edit Profile Modify the current Patient Profile being used by the Interactive Display screen. This section is divided into four separate links that allows the user to move directly to the Patient Information, Patient Disease/Diagnosis Profile, Patient Optional Phenotypic Profile, or Patient Substance Profile.
Profile Analysis Return to the Profile Analysis screen and re-analyze the current profile. This allows the user to obtain additional substance suggestions based on hypothetical analysis made to the current Patient Profile.
Profile Review Return to the Profile Review screen.
Add New Profile Release the current Patient Profile and create a new one by returning the user to the Patient Information screen. The data contained within the old Patient Profile is still saved in the system.
My Saved Profiles Based on the user's security permissions, allows the user to view all their saved profiles and select a saved profile for editing or viewing in the Interactive Display. In addition, Patient Profiles can be deleted from this screen.
Log Out Logs the user out of the system.

A Legend 312 is located in the lower, right-hand corner of the screen, and provides a colorful and visual definition of the elements used to produce the Interaction Diagram. In addition, a detailed description of how to read the Interaction Diagram along with definitions for each of the pathway elements and gene variants is provided by following the Diagram Explained link.

Reports: Various disclosed embodiments can provide one or more of the following five (5) reports based on the active or current Patient Profile, and can also offer other reports. The user will be offered the option of sending the report to a printer or saving the report in a file is a data processing system storage, that can be accessed later, used as an email attachment, transmitted to another system, displayed, and/or archived.

A comprehensive report details all information related to the Patient Profile, Interaction Diagram, and Information Tabs for a given Patient Profile. It is comprised of all the data used to produce the various Section Reports discussed below.

A Patient Profile report details all the information within the Patient Profile section including patient demographics, disease/diagnosis, phenotypic data, substances, and the result of the Patient Analysis.

A Patient Analysis report contains the results of the Patient Analysis section for this Patient Profile. It is intended as a review document for the physician/pharmacist and the patient.

An Interaction Diagram report provides an output of the Interaction Diagram including the option of printing the contents of the Information Tabs on the report.

Information Tabs Report: This report provides all the information contained in the Information Tabs.

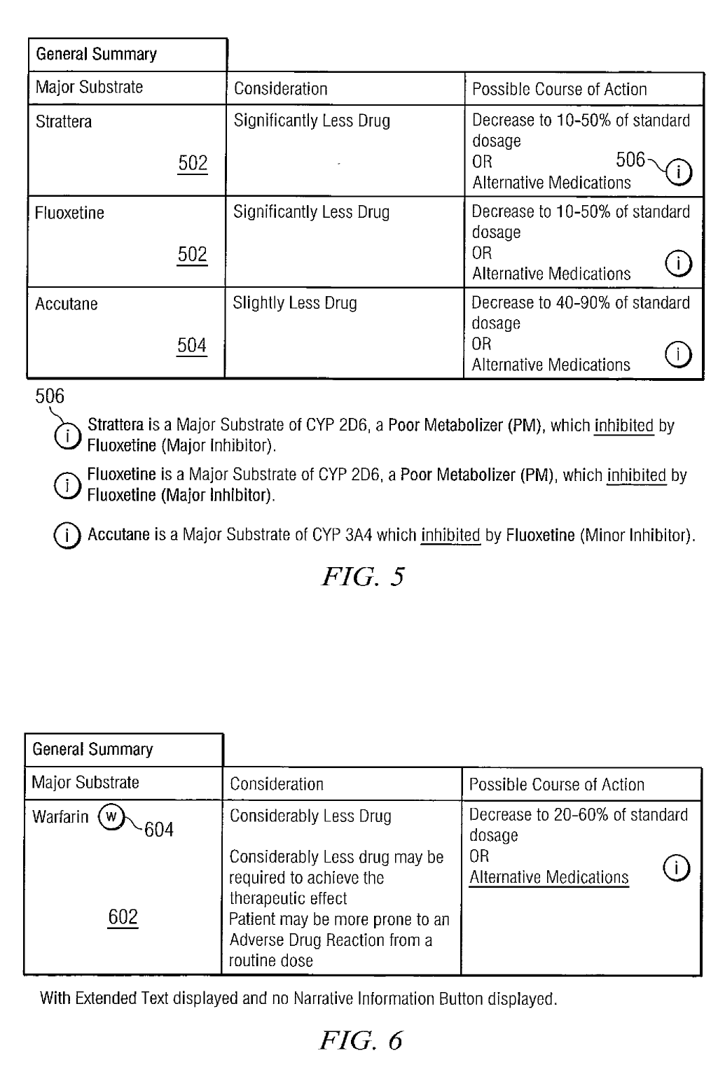

FIG. 4 depicts a flowchart of a weighing process as used by various embodiments as described below. The following describes one process used by the system to calculate a Summation Value for each Substrate gene entered in the patient profile. The Summary Statement associated with this value can be then formatted and displayed in the General Summary tab. The General Summary tab is intended to be a quick and informative narrative interpretation of Interaction Diagram for this patient profile. It also provides a quick link to the Alternative Medications tab for each Substrate listed.

Various steps in the process of FIG. 4 are described in detail below. The process can be performed in a data processing system such as that depicted in FIG. 1, and can be performed by a server data processing system in communication with a client data processing system.

The system receives a patient profile (step 405) corresponding to a patient (real or hypothetical), which can include loading it from storage, receiving it from another system or receiving it via a user interaction, as in the process of FIG. 2, above. The data entered during this stage and received by the system will be used to determine the interactions as described below. The patient profile can correspond to that discussed above, and can include the individual gene variants corresponding to the patient.

For one or more of the substances identified in the patient profile, the system determines which genes interact with, are effected by, or are otherwise associated with the substance (step 410).

The system performs a weighing process according to the substance and the gene with which it is associated (step 415) to determine a summation value. The weighing process and summation value are described in more detail below, and uses the individual gene variants corresponding to the patient. The summation value can correspond, for example, to the patient-specific gene variant and a drug interaction value between the gene and the substance, or to the patient-specific gene variant and a sum of drug interaction values between the gene and the plurality of substances, or otherwise as described herein.

The system determines an interaction between the substance and the gene according to the weighing process (step 420) according to the summation value. This interaction is stored in the system and/or transmitted for storage.

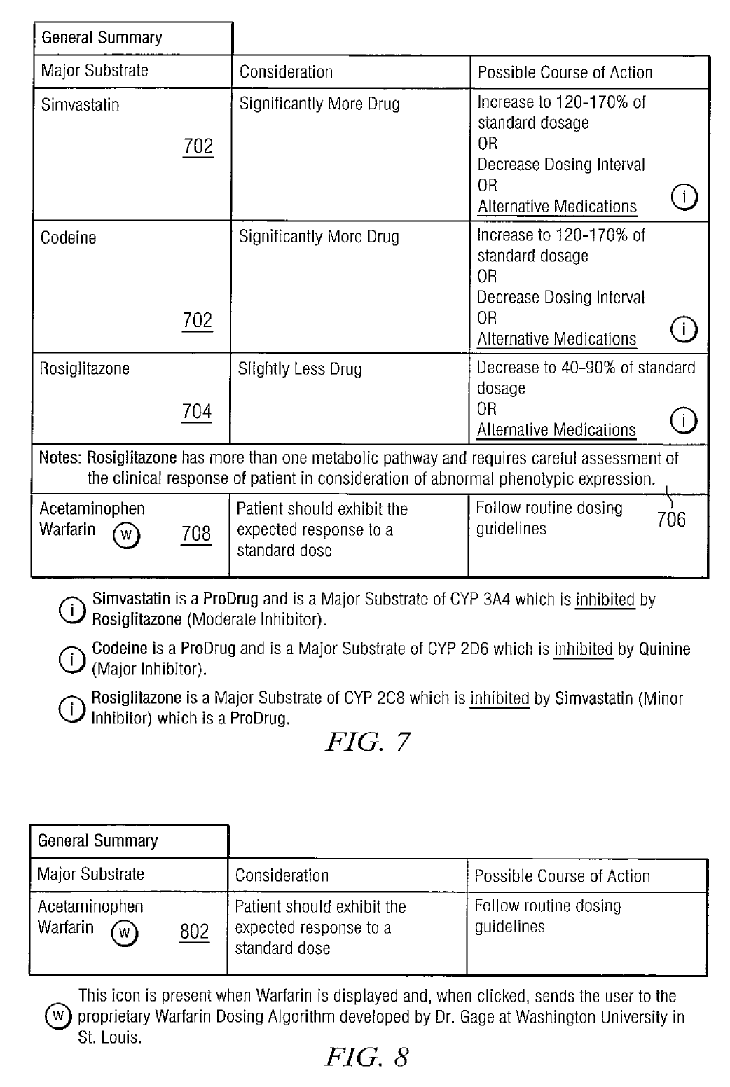

The system displays a summary showing the interaction between the substance and the gene (step 425) according to the summation value. As described below, the summary is preferably both graphical and color-coded for easy and intuitive review. Preferably, as illustrated in the interaction diagram 304, the summary displays a graphical representation of the substances and phenotypic information entered in the Patient Profile and their interaction with the associated genes, using color-coded lines to show the interaction of the substance and the gene, as described below. Further, the summary also or alternately includes a table showing each major substrate substance, a consideration based on the summation value, and a possible course of action based on the summation value and other information regarding the substance. This table preferably also includes color coding and any relevant specific notes with regard to each substances, and can can also include hotlinks, either local or over a network, to further information, alternative medications, and other data. Examples of such tables are shown in FIGS. 5-8.

Preferably, steps 410-420 are performed for each substance in the patient profile, and the summary in step 425 therefore shows the interaction between all substances in the patient profile and each gene, according to the summation value, as in interaction diagram 304. Of course, in various embodiments, a user can select which of the substances and corresponding interactions are analyzed and displayed according to this process.

This weighing process uses one or more of the following rules.

1. Ultra Rapid Metabolizer and HyperInducer genetic variations are weighed with negative numbers. Logically, this is intended to illustrate how more rapid metabolism of a substance will decrease (LESS) the amount of active component available to have a pharmacologic affect as would be expected from a normal metabolizer.

2. Intermediate and Poor Metabolizers genetic variations are weighted with positive numbers. Logically, this is intended to illustrate how slower metabolism of a substance will increase (MORE) the amount of active component available to have a pharmacologic affect as would be expected from a normal metabolizer.

3. The weighted numeric established for the drug interaction values is based on established definitions for each category, and is described in more detail below. For the Inhibitors, these values are specifically linked to Ki values. Ki is the symbol for the dissociation constant of an inhibitor; in enzyme kinetics, Kii reflects the values of Ki that affect the intercept of a double-reciprocal plot while Kis reflects the values of Ki that affect the slope of the same plot.

4. ProDrug values will be reversed from the above numerical relationships when drug-gene interactions are evaluated. This will accommodate the metabolic nature of the ProDrug. Thus, an increase of the level of ProDrug will mean LESS of the active form will be available. Likewise, a decrease of the active form would mean MORE of the active form available. ProDrug values are only considered if the ProDrug is a major substrate and are generally calculated for the summation drug only. As known to those of skill in the art, a ProDrug is a pharmacological substance (drug) that is administered in an inactive (or significantly less active) form. Once administered, the prodrug is metabolized in vivo into an active metabolite. The rationale behind the use of a prodrug is generally for absorption, distribution, metabolism, and excretion (ADME) optimization.

5. All drugs, herbals, over the counter medication (OTCs), and environmental factors (such as, smoking, etc.) are weighted equally regardless of frequency or time of administration. These agents all exhibit a binary relationship to the algorithm and, if present, are weighted based on the drug interaction value.

6. If there is no Inducer present, then the Hyper Inducer Gene is always weighted at zero (0).

7. A Major Substrate must be present to produce a Summation Value. The Summation Value always refers to the Major Substrate of a Drug or over the counter medication, never for food or nutrient. If there is no Major Substrate for a drug or over the counter medication present, then no Summation Value is produced.

8. If a drug has more than one Major Substrate metabolic pathway, the following comment will be displayed on the General Summary tab, “Drug XYZ has more than one metabolic pathway and requires careful assessment of the clinical response of patient in consideration of abnormal phenotypic expression”.

Numerical Weighing of Drug Interactions and Gene Variants: The following Numerical Weighing process uses values based on established definitions for each category. For the Inhibitors, these values are specifically linked to Ki values.

| | CYP Gene Variants: |
|---|---|
| Poor Metabolizer: | 6 |
| Intermediate Metabolizer: | 3 |
| Extensive Metabolizer: | 0 |
| Hyper Inducer: | −2 |
| Ultra Rapid Metabolizer: | −6 |
| | Drug Interaction Values: |
| Major Inhibitor: | 3 |
| Moderate Inhibitor: | 2 |
| Minor Inhibitor: | 1 |
| Major Substrate: | 0 |
| Minor Substrate: | 0 |
| Minor Inducer: | −1 |
| Major Inducer: | −2 |

For every drug with a major substrate interface to a gene, in some embodiments, the process uses the formula:

$$Summation Value = ( ProDrug Value ) ( Gene Variant + {\sum }_{k = 1}^{n} ( Drug Interaction {Value}_{k} ) )$$

Where ProDrug Value is (−1) if the drug used in the Summation Value is a ProDrug and a Major Substrate; otherwise ProDrug Value is (+1). The drug interaction values are summed over all the other substances present in the patient profile with which the subject drug will interact, in accordance with the table above. The Gene Variant, as described herein, is specific to the patient based on the genetic analysis in the patient profile.

Summary Statements: In various embodiments, the system presents a summary, including displaying, storing, printing or transmitting the summary. The summary can include a graphical representation of each of the plurality of substances, a gene with which each substance interacts, and the type of interaction between each substance and a corresponding gene, such as that depicted in FIG. 2, and can be color-coded. The summary can also or alternately include a description of patient dosing considerations according to the first substance and the determined interaction, and/or a description of a possible course of action according to the first substance and the determined interaction.

In some embodiments, color coding of the summary results is used, as indicated by the exemplary colors shown in the table below. The color coding gives an easy and intuitive way for a user to quickly understand the summary results.

| Summation | | Possible Course | |
|---|---|---|---|
| Value | Consideration | of Action | Color |
| 0 | Patient should | Follow routine | Pale Southwest |
| | exhibit the | dosing guidelines | Green |
| | expected response | | (Note: Comment is |
| | to a standard | | not displayed if |
| | dose | | drug combination |
| | | | results in a |
| | | | Summation Value |
| | | | other than zero |
| | | | AND is displayed |
| | | | only once |
| | | | regardless of how |
| | | | many zero values |
| | | | (Major Substrates) |
| | | | are present) |
| 1 | Slightly Less Drug | Decrease to 40- | Light Southwest |
| | Expanded Text | 90% of standard | Yellow |
| | Slightly less drug | dosage | (Note: These |
| | may be required to | OR | exemplary colors |
| | achieve therapeutic | Alternative | follow a Southwest |
| | effect. Patient may | Medications | color scheme. This |
| | be more prone to | (Note: This link | is the lightest |
| | an Adverse Drug | will go directly to | yellow color in the |
| | Reaction from a | Alternative | sequence meaning |
| | routine dose. | Medications for | it is possesses the |
| | (Note: Expanded | the Major Sub- | lowest level of risk- |
| | Text is available | strate in question) | yellow grouping) |
| | by clicking on | | Risk Level: 1 of 4 |
| | brief text above) | | |
| 2-4 | Less Drug | Decrease to 30- | Southwest Yellow |
| | Expanded Text | 70% of standard | (Note: This is the |
| | Less drug may be | dosage | next yellow color |
| | required to achieve | OR | in the sequence |
| | the therapeutic | Alternative | meaning it is |
| | effect | Medications | possesses the |
| | Patient may be more | | highest level of risk- |
| | prone to an Adverse | | yellow grouping) |
| | Drug Reaction from | | Risk Level: 2 of 4 |
| | a routine dose | | |
| 5-8 | Considerably Less | Decrease to 20- | Light Southwest |
| | Drug | 60% of standard | Red |
| | Expanded Text | dosage | (Note: This is the |
| | Considerably Less | OR | lightest red color in |
| | drug may be | Alternative | the sequence |
| | required to achieve | Medications | meaning it is |
| | the therapeutic | | possesses the lowest |
| | effect | | level of risk- |
| | Patient may be more | | within the red |
| | prone to an Adverse | | grouping) |
| | Drug Reaction from | | Risk Level: 3 of 4 |
| | a routine dose | | |
| 9 or > | Significantly Less | Decrease to 10- | Southwest Red |
| | Drug | 50% of standard | (Note: This is the |
| | Expanded Text | dosage | next red color in the |
| | Significantly Less | OR | sequence meaning it |
| | drug may be | Alternative | is possesses the |
| | required to achieve | Medications | highest level of risk- |
| | the therapeutic | | within the red |
| | effect Patient may | | grouping) |
| | be prone to an | | Risk Level: 4 of 4 |
| | Adverse Drug | | |
| | Reaction from a | | |
| | routine dose | | |
| (−1)-(−3) | More Drug | Increase to 100- | Light Southwest |
| | Expanded Text | 130% of standard | Yellow |
| | More drug may be | dosage | (Note: This is the |
| | required to achieve | OR | next yellow color in |
| | the therapeutic | Decrease Dosing | the sequence |
| | effect | Interval | meaning it is |
| | | OR | possesses the |
| | | Alternative | highest level of risk- |
| | | Medications | yellow grouping) |
| | | | Risk Level: 2 of 4 |
| (−4) or < | Significantly More | Increase to 120- | Light Southwest |
| | Drug | 170% of standard | Red |
| | Expanded Text | dosage | (Note: This is the |
| | Significantly more | OR | next red color in the |
| | drug may be | Decrease Dosing | sequence meaning it |
| | required to achieve | Interval | is possesses the |
| | the therapeutic | OR | highest level of risk- |
| | effect | Alternative | within the red |
| | | Medications | grouping) |
| | | | Risk Level: 4 of 4 |

A Narrative Information Button is a small icon next to the Summation State that describes the Drug-Gene interaction in a narrative format.

The following description and related figures illustrate patient examples as presented by embodiments of the disclosed system.

Patient 1:

| | Drug | | Gene |
|---|---|---|---|
| Substance | Interaction | Gene | Variant |
| Strattera | Major | CYP 2D6 | Poor |
| | Substrate | | Metabolizer |
| Fluoxetine | Major | CYP 2D6 | Poor |
| | Substrate | | Metabolizer |
| Fluoxetine | Major | CYP 2D6 | Poor |
| | Inhibitor | | Metabolizer |
| Fluoxetine | Minor | CYP 3A4 | None |
| | Inhibitor | | |
| Accutane | Major | CYP 3A4 | None |
| | Substrate | | |

Strattera Summation Value-For Gene CYP 2D6

| | |
|---|---|
| Strattera (Major Substrate) | Drug Interaction Value = 0 |
| Fluoxetine (Major Inhibitor) | Drug Interaction Value = 3 |
| CYP 2D6 (Poor Metabolizer) | Gene Variant = 6 |

Strattera Summation Value = 9

Fluoxetine Summation Value-For Gene CYP 2D6

| | |
|---|---|
| Fluoxetine (Major Substrate) | Drug Interaction Value = 0 |
| Fluoxetine (Major Inhibitor) | Drug Interaction Value = 3 |
| CYP 2D6 (Poor Metabolizer) | Gene Variant = 6 |

Fluoxetine Summation Value = 9

Accutane Summation Value-For Gene CYP 3A4

| | |
|---|---|
| Accutane (Major Substrate) | Drug Interaction Value = 0 |
| Fluoxetine (Minor Inhibitor) | Drug Interaction Value = 1 |

Accutane Summation Value = 1

FIG. 5 depicts a summary table for example Patient 1. In this example, the Strattera and Fluoxetine lines 502 can be shown in a southwest red color (recognizing that the colors are not reproduced in this patent document), indicating a highest level of risk, while the Accutane line 504 is shown in light southwest yellow, indicating a lowest level of risk. Each line also has a Narrative Information Button 506, that when selected causes the system to display the corresponding narrative 508.

Patient 2:

| | Drug | | Gene |
|---|---|---|---|
| Substance | Interaction | Gene | Variant |
| Warfarin | Major | CYP 2C9 | Poor |
| | Substrate | | Metabolizer |
| Amiodarone | Moderate | CYP 2C9 | Poor |
| | Inhibitor | | Metabolizer |

Warfarin Summation Value-For Gene CYP 2C9

| | |
|---|---|
| Warfarin (Major Substrate) | Drug Interaction Value = 0 |
| Amiodarone (Moderate Inhibitor) | Drug Interaction Value = 2 |
| CYP 2C9 (Poor Metabolizer) | Gene Variant = 6 |

Warfarin Summation Value = 8

FIG. 6 depicts a summary table for example Patient 2, with Extended Text displayed and no Narrative Information Button displayed. In this example, the Wayfarin line 602 can be shown in a light southwest red color, indicating a moderate level of risk Note also the Warfarion icon 604, which is present when Warfarin is displayed andcan link a user to the proprietary Warfarin Dosing Algorithm developed by Dr. Gage at Washington University in St. Louis.

Patient 3:

| | Drug | | Gene |
|---|---|---|---|
| Substance | Interaction | Gene | Variant |
| Warfarin | Major Substrate | CYP 2C9 | None |
| Rosiglitazone | Major Substrate | CYP 2C9 | None |
| Rosiglitazone | Major Substrate | CYP 2C8 | None |
| Rosiglitazone | Moderate Inhibitor | CYP 3A4 | None |
| Simvastatin | Major Substrate | CYP 3A4 | None |
| (ProDrug) | | | |
| Simvastatin | Minor Inhibitor | CYP 2C8 | None |
| (ProDrug) | | | |
| Acetaminophen | Major Substrate | CYP 2E1 | None |
| Acetaminophen | Minor Substrate | CYP 3A4 | None |
| Acetaminophen | Minor Substrate | CYP 2D6 | None |
| Acetaminophen | Minor Substrate | CYP 2A6 | None |
| Acetaminophen | Minor Substrate | CYP 1A2 | None |
| Codeine | Major Substrate | CYP 2D6 | None |
| (ProDrug) | | | |
| Quinine | Major Inhibitor | CYP 2D6 | None |
| Lisinopril | | No CYP | |
| Dothiepin | | No Data | |

Warfarin Summation Value-For Gene CYP 2C9

| | |
|---|---|
| Warfarin (Major Substrate) | Drug Interaction Value = 0 |

Warfarin Summation Value = 0

Rosiglitazone Summation Value-For Gene CYP 2C9

| | |
|---|---|
| Rosiglitazone (Major Substrate) | Drug Interaction Value = 0 |

Rosiglitazone Summation Value = 0

Rosiglitazone Summation Value-For Gene CYP 2C8

| | |
|---|---|
| Rosiglitazone (Major Substrate) | Drug Interaction Value = 0 |
| Simvastatin (Minor Inhibitor) | Drug Interaction Value = 1 |

ProDrug Multiple = 1
Rosiglitazone Summation Value = (1)

Simvastatin Summation Value-For Gene CYP 3A4

| | |
|---|---|
| Simvastatin (Major Substrate) | Drug Interaction Value = 0 |
| Acetaminophen (Minor Substrate) | Drug Interaction Value = 0 |
| Rosiglitazone (Moderate Inhibitor) | Drug Interaction Value = 2 |

ProDrug Multiple = −1
Simvastatin Summation Value = (−2)

Acetaminophen Summation Value-For Gene CYP 2E1

| | |
|---|---|
| Acetaminophen (Major Substrate) | Drug Interaction Value = 0 |

Acetaminophen Summation Value = 0

Codeine Summation Value-For Gene CYp 2D6

| | |
|---|---|
| Codeine (Major Substrate) | Drug Interaction Value = 0 |
| Acetaminophen (Minor Substrate) | Drug Interaction Value = 0 |
| Quinine (Major Inhibitor) | Drug Interaction Value = 2 |

ProDrug Multiple = −1
Codeine Summation Value = (−2)

FIG. 7 depicts a summary table for example Patient 3. In this example, the Simvastatin and Codeine lines 702 can be shown in a southwest red color, indicating a highest level of risk, while the Rosiglitazon line 704 is shown in light southwest yellow, indicating a lowest level of risk. A note 706 is also shown, warning that Rosiglitazone has more than one metabolic pathway; such a line can be shown whenever a substance is considered that may have unusual characteristics that should be considered. The Acetaminophen/Warfarin line 708 is shown in pale southwest green, indicating that no adjustments to this dosing are likely to be necessary.

Patient 4:

| | Drug | | Gene |
|---|---|---|---|
| Substance | Interaction | Gene | Variant |
| Warfarin | Major | CYP 2C9 | none |
| | Substrate | | |
| Acetaminophen | Major | CYP 2E1 | None |
| | Substrate | | |
| Acetaminophen | Minor | CYP 3A4 | None |
| | Substrate | | |
| Acetaminophen | Minor | CYP 2D6 | None |
| | Substrate | | |
| Acetaminophen | Minor | CYP 2A6 | None |
| | Substrate | | |
| Acetaminophen | Minor | CYP 1A2 | None |
| | Substrate | | |

Warfarin Summation Value-For Gene CYP 2C9

| | |
|---|---|
| Warfarin (Major Substrate) | Drug Interaction |
| Warfarin Summation Value = 0 | Value = 0 |

Acetaminophen Summation Value-For Gene CYP 2E1

| | |
|---|---|
| Acetaminophen (Major Substrate) | Drug Interaction |
| Acetaminophen Summation Value = 0 | Value = 0 |

FIG. 8 depicts a summary table for example Patient 4. In this example, the Acetaminophen/Warfarin line 802 is shown in pale southwest green, indicating that no adjustments to this dosing are likely to be necessary.

Of course, the example summaries and screens are only examples, and can be modified in different implementations. The processes described herein may include optional steps, steps that can be performed in a different order, or steps that can be performed concurrently. The examples used herein are not intended to be limiting, and the appended claims will describe any specific requirements of the claimed embodiments.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 100 may conform to any of the various current implementations and practices known in the art.

It is important to note that while the disclosure includes a description in the context of a fully functional system that can be configured as a particular machine to perform steps as described herein, those skilled in the art will appreciate that at least portions of the mechanism of the present disclosure are capable of being distributed in the form of a instructions contained or encoded within a machine-usable, computer-usable, or computer-readable medium in any of a variety of forms, and that the present disclosure applies equally regardless of the particular type of instruction or signal bearing medium or storage medium utilized to actually carry out the distribution. Embodiments include a machine-readable medium encoded with instructions that, when executed, cause a data processing system to perform processes as described herein. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke paragraph six of 35 USC §112 unless the exact words “means for” are followed by a participle.

What is claimed is:

1. A method for developing a patient profile in a data processing system, comprising:
receiving a patient profile in a data processing system, the patient profile including a patient substance profile identifying at least one initial substance consumed by a patient;
identifying at least one additional substance by the data processing system, based on the patient profile, that has a potential effect on the patient;
presenting the at least one additional substance to a user; and
receiving and storing a change to the patient profile in the data processing system based on the at least one additional substance.

2. The method of claim 1, wherein identifying at least one additional substance includes identifying any additional substances that are inhibitors or inducers to the gene.

3. The method of claim 1, wherein identifying at least one additional substance includes indentifying an additional substance with a potential adverse effect associated with the initial substance and a patient demographic.

4. The method of claim 1, wherein identifying at least one additional substance includes indentifying an additional substance with a potential adverse effect associated with the initial substance and a patient medical condition.

5. The method of claim 1, wherein identifying at least one additional substance includes indentifying an additional substance that has a known contraindication associated with the initial substance.

6. A method for developing a patient profile in a data processing system, comprising:
receiving a patient profile in a data processing system, the patient profile including a patient substance profile identifying a plurality of substances consumed by a patient and at least one patient-specific gene variant;
identifying, by the data processing system, a gene associated with a first one of the plurality of substances;
performing a weighing process by the data processing system according to the first substance to determine an interaction between the first substance and the gene; and
producing a summary by the data processing system according to the determined interaction.

7. The method of claim 6, wherein performing the weighing process includes determining a summation value corresponding to the patient-specific gene variant and a drug interaction value between the gene and the substance.

8. The method of claim 6, wherein performing the weighing process includes determining a summation value corresponding to the patient-specific gene variant and a sum of drug interaction values between the gene and the plurality of substances.

9. The method of claim 6, wherein the summary includes a graphical representation of each of the plurality of substances, a gene with which each substance interacts, and the type of interaction between each substance and a corresponding gene.

10. The method of claim 6, wherein the summary includes a description of patient dosing considerations according to the first substance and the determined interaction.

11. The method of claim 6, wherein the summary includes a description of a possible course of action according to the first substance and the determined interaction.

12. A data processing system comprising a processor and accessible memory, the data processing system particularly configured to perform the steps of:
receiving a patient profile, the patient profile including a patient substance profile identifying at least one initial substance consumed by a patient;
identifying at least one additional substance, based on the patient profile, that has a potential effect on the patient;
presenting the at least one additional substance to a user; and
receiving and storing a change to the patient profile based on the at least one additional substance.

13. The data processing system of claim 12, wherein identifying at least one additional substance includes identifying any additional substances that are inhibitors or inducers to the gene.

14. The data processing system of claim 12, wherein identifying at least one additional substance includes indentifying an additional substance with a potential adverse effect associated with the initial substance and a patient demographic.

15. The data processing system of claim 12, wherein identifying at least one additional substance includes indentifying an additional substance with a potential adverse effect associated with the initial substance and a patient medical condition.

16. The data processing system of claim 12, wherein identifying at least one additional substance includes indentifying an additional substance that has a known contraindication associated with the initial substance.

17. A data processing system comprising a processor and accessible memory, the data processing system particularly configured to perform the steps of:
receiving a patient profile, the patient profile including a patient substance profile identifying a plurality of substances consumed by a patient and at least one patient-specific gene variant;
identifying a gene associated with a first one of the plurality of substances;
performing a weighing process according to the first substance to determine an interaction between the first substance and the gene; and
producing a summary according to the determined interaction.

18. The data processing system of claim 17, wherein performing the weighing process includes determining a summation value corresponding to the patient-specific gene variant and a drug interaction value between the gene and the substance.

19. The data processing system of claim 17, wherein performing the weighing process includes determining a summation value corresponding to the patient-specific gene variant and a sum of drug interaction values between the gene and the plurality of substances.

20. The data processing system of claim 17, wherein the summary includes a graphical representation of each of the plurality of substances, a gene with which each substance interacts, and the type of interaction between each substance and a corresponding gene.

21. The data processing system of claim 17, wherein the summary includes a description of patient dosing considerations according to the first substance and the determined interaction.

22. The data processing system of claim 17, wherein the summary includes a description of a possible course of action according to the first substance and the determined interaction.

23. A machine-readable storage medium encoded with computer-executable instructions that, when executed, cause one or more data processing systems to collectively perform the steps of:
receiving a patient profile, the patient profile including a patient substance profile identifying at least one initial substance consumed by a patient;
identifying at least one additional substance, based on the patient profile, that has a potential effect on the patient;
presenting the at least one additional substance to a user; and
receiving and storing a change to the patient profile based on the at least one additional substance.

24. The machine-readable storage medium of claim 23, wherein identifying at least one additional substance includes identifying any additional substances that are inhibitors or inducers to the gene.

25. The machine-readable storage medium of claim 23, wherein identifying at least one additional substance includes indentifying an additional substance with a potential adverse effect associated with the initial substance and a patient demographic.

26. The machine-readable storage medium of claim 23, wherein identifying at least one additional substance includes indentifying an additional substance with a potential adverse effect associated with the initial substance and a patient medical condition.

27. The machine-readable storage medium of claim 23, wherein identifying at least one additional substance includes indentifying an additional substance that has a known contraindication associated with the initial substance.

28. A machine-readable storage medium encoded with computer-executable instructions that, when executed, cause one or more data processing systems to collectively perform the steps of:
receiving a patient profile, the patient profile including a patient substance profile identifying a plurality of substances consumed by a patient and at least one patient-specific gene variant;
identifying a gene associated with a first one of the plurality of substances;
performing a weighing process according to the first substance to determine an interaction between the first substance and the gene; and
producing a summary according to the determined interaction.

29. The machine-readable storage medium of claim 28, wherein performing the weighing process includes determining a summation value corresponding to the patient-specific gene variant and a drug interaction value between the gene and the substance.

30. The machine-readable storage medium of claim 28, wherein performing the weighing process includes determining a summation value corresponding to the patient-specific gene variant and a sum of drug interaction values between the gene and the plurality of substances.

31. The machine-readable storage medium of claim 28, wherein the summary includes a graphical representation of each of the plurality of substances, a gene with which each substance interacts, and the type of interaction between each substance and a corresponding gene.

32. The machine-readable storage medium of claim 28, wherein the summary includes a description of patient dosing considerations according to the first substance and the determined interaction.

33. The machine-readable storage medium of claim 28, wherein the summary includes a description of a possible course of action according to the first substance and the determined interaction.
